(19) United States
(12) Patent Application Publication
(10) Pub. No.: US 2010/0227671 A1
(43) Pub. Date: Sep. 9, 2010

(54) APPARATUS FOR GATHERING, TRANSFERRING, AND AUDITING PAYMENT INFORMATION

(76) Inventors: Mohamed Laaroussi, Orford (CA); Hugues Boisvert, Sherbrooke (CA); Eric Levesque, Sherbrooke (CA)

Correspondence Address: AxesNetwork Inc.;Attn.: Intellectual Property Department, 410 Pepin Street, Sherbrooke, QC, J1L 2Y8, CA

(21) Appl. No.: 12/475,025

(22) Filed: May 29, 2009

(30) Foreign Application Priority Data
Mar. 5, 2009 (CA) 2658676

(51) Int. Cl. A63F 9/24; G06F 12/00; G06F 13/38; G06Q 40/00

(52) U.S. Cl. 463/25; 711/115; 710/72; 705/30; 711/E12.001

(57) ABSTRACT

A currency media reader hub on a gaming machine to monitor transactions is provided. The currency media reader hub comprises a communication board module comprising a communication port module adapted to connect the currency media reader hub with a peripheral component, a network port module adapted to connect the currency media reader hub to a network, a currency media reader module connected to the communication board module, the currency media reader module being adapted to communicate with a virtual currency holding media and transfer data between the communication board module and the virtual currency holding media, a user interface module connected to the communication board and adapted to display a currency value stored on the virtual currency holding media and an intelligent board module connected to the communication board to provide communication capability with the network.

### CROSS-REFERENCE

The present United States patent application relates to and claims priority from Canadian Patent Application No. 2,658,676, filed on Mar. 5, 2009, entitled NOVEL METHOD OF GATHERING, TRANSFERRING, AND AUDITING PAYMENT INFORMATION, which is enclosed herein by reference.

### FIELD OF THE INVENTION

The present invention relates to a currency media reader adapted to connect a network to remotely manage payment information. The present invention more precisely relates to a currency media reader hub adapted to be retrofitted in a gaming machine and to interconnect various existing components thereof.

### BACKGROUND OF THE INVENTION

Gaming machines are commonly used in the gaming or amusement industries. Generally, the gaming machines accept payment in the form of bills, coins, tickets, token and other types of currencies.

Each gaming machine is adapted to individually receive payment therein. Accounting of currency transactions and statistics of use are useful yet complicated to obtain given the limited communication between each gaming machine.

A mechanism improving collective communication among gaming machines and providing accounting of currency transactions and statistics of use is therefore desirable.

### SUMMARY OF THE INVENTION

It is an object of the present invention to ameliorate at least some of the inconveniences present in the prior art.

In view of the foregoing, one object of the present invention provides a mechanism adapted to improve communication between a plurality of gaming machines and a server.

One object of the present invention provides an apparatus permitting remote gathering, transferring and auditing payment information.

Another object of the present invention provides a database/datacenter adapted to record transaction events for safekeeping and reporting.

An object of the present invention provides a currency media reader hub adapted to communicate with a gaming machine and a peripheral component in its communication mode such that the currency media reader hub can be retrofitted between the gaming machine and the peripheral component.

An object of the present invention provides a currency media reader hub emulating a peripheral component installed on a gaming machine; the peripheral component could be a money acceptor peripheral to transfer money to the gaming machine.

An additional object of the present invention provides a gaming machines management system using a remote server; the gaming machines communicating with the remote server via currency media reader hubs respectively locally connected on the gaming machine and communicating with the server using standard an Internet Protocol network and Internet.

One another object of the present invention provides a currency media reader hub providing both online and offline working capability to a gaming machine so that service is kept even if the network is down.

Another object of the present invention provides a currency media reader hub adapted to obtain, update or change its configuration from a remote web service.

One other object of the present invention provides a currency media reader hub adapted to account an amount of money stored in a virtual currency media.

An aspect of the present invention provides a currency media reader hub having embedded TCP/IP communication capability.

One aspect of the present invention provides a currency media reader hub adapted to emulate a standard payment acceptance module such as a bill acceptor module or coin acceptor module; the standard payment acceptance module originally connected to the gaming machine may be connected directly to the currency media reader hub that, itself, is connected to the gaming machine and provide communication thereto.

One another object of the present invention provides a mechanism adapted to store events (i.e. transactions, play actions . . . ) occurring on a gaming machine in a network based datacenter.

An aspect of the present invention provides one or more point of sale (POS) terminals used, inter alia, to add or remove money on a virtual currency holding media.

A further aspect of the present invention provides a POS terminal adapted to connect to a datacenter to obtain gaming data from gaming machines.

Another aspect of the present invention provides a currency media reader hub emulating a gaming machine to accept money from peripherals installed thereon.

One another aspect of the present invention provides a currency media reader hub that is an escrow device adapted to hold payments in a gaming machine until a virtual currency holding media is connected thereto.

Another aspect of the present invention provides a currency media reader hub adapted to transfer an amount of money from the virtual currency holding media to a gaming machine either automatically or by user request.

One other aspect of the present invention provides a currency media reader hub adapted to act as a gateway and a translator between peripherals (bill acceptor, coin acceptor, etc) and the gaming machine.

An aspect of the present invention provides a system adapted to manage gaming machines using only cash-in and cash-out transactions, without using hand-counts or interfacing directly with a controller board of the gaming machine.

Another aspect of the present invention provides a currency media reader hub adapted to store transactions occurring on a gaming machine in a memory when there is no connection with a network and adapted to send the transactions stored therein to a server through the network when the network is connected thereto.

Another aspect of the present invention provides a point of sale (POS) terminal adapted to download a list of queries to be executed by a server upon demand, wherein the server returns the results in a pre-formatted ticket ready for printing by the POS terminal or for displaying on the user interface module.

One aspect of the present invention provides a SIM/SAM card to store a configuration to the currency media reader hub to make it easily replaceable in the field.

An aspect of the present invention provides a currency media reader hub adapted to obtain firmware updates from a remote web service.

Another aspect of the present invention provides a currency media reader hub comprising a communication board module comprising a communication port module adapted to connect the currency media reader hub with a peripheral component; a network port module adapted to connect the currency media reader hub to a network; a currency media reader module connected to the communication board module, the currency media reader module being adapted to communicate with a virtual currency holding media and transfer data between the communication board module and the virtual currency holding media; a user interface module connected to the communication board and adapted to display a currency value stored on the virtual currency holding media; and an intelligent board module connected to the communication board to provide communication capability with the network, the intelligent board module comprising an IP MAC address module adapted to identify the currency media reader hub on the network; a memory module for storing data; a clock module; and an input/output port module.

One additional aspect of the present invention provides a method for connecting a currency media reader hub to a gaming machine, the method comprising disconnecting a currency receiver module from the gaming machine; connecting the currency receiver module to the currency media reader hub; and connecting the currency media reader hub to the gaming machine so that the currency receiver module and the gaming machine communicate therebetween.

One additional aspect of the present invention provides a computer readable media comprising computer executable instruction providing a method for connecting a currency media reader hub to a gaming machine, the method comprising selecting a communication mode suitable to communicate between the gaming machine and the currency media reader hub, the communication mode being selected from a pulse string communication mode, a serial communication mode and a universal serial bus mode.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

### BRIEF DESCRIPTION OF THE DRAWINGS

For a better understanding of the invention as well as other objects and further features thereof, reference is made to the following detailed description to be read in conjunction with the accompanying drawings, where:

FIG. 1 is a schematic illustration of a network based gaming system with a plurality of gaming machines;

FIG. 2 is a schematic illustration of an exemplary construction of a gaming machine;

FIG. 3 is a schematic illustration of a gaming machine having peripheral components connected thereto via a currency media reader hub;

FIG. 4 is a block diagram of a currency media reader hub in accordance with an embodiment of the present invention;

FIG. 5 is a schematic illustration of a network based gaming system in accordance with an embodiment of the present invention;

FIG. 6 is an exemplary flow chart of a process associated with en embodiment of the present invention;

FIG. 7 is an exemplary flow chart of a process associated with en embodiment of the present invention; and

FIG. 8 is an exemplary flow chart of a process associated with en embodiment of the present invention.

### DESCRIPTION OF EMBODIMENT(S) OF THE INVENTION

The present invention is now described with reference to the figures. In the following description, for purposes of explanation, numerous specific details are set forth in order to provide a thorough understanding of the present invention by way of embodiment(s). It may be evident, however, that the present invention may be practiced without these specific details. In other instances, well-known structures and devices are shown in block diagram form in order to facilitate describing the present invention.

The features provided in this specification mainly, but might not exclusively, relate to principles of computer software and machine-readable code/instructions adapted to instruct a computer, many computers or other machines, namely gaming machines, adapted to use the instructions to provide material effects on a display, or other means enabling human-computer interactions to manage money, currency, menus, user-selectable elements and other elements involved in playing with gaming machines. These code/instructions are preferably stored on a machine-readable medium to be read and acted upon to with a gaming machine, slot machine, computer or another machine having the appropriate code/instructions reading capability.

Exemplary Network

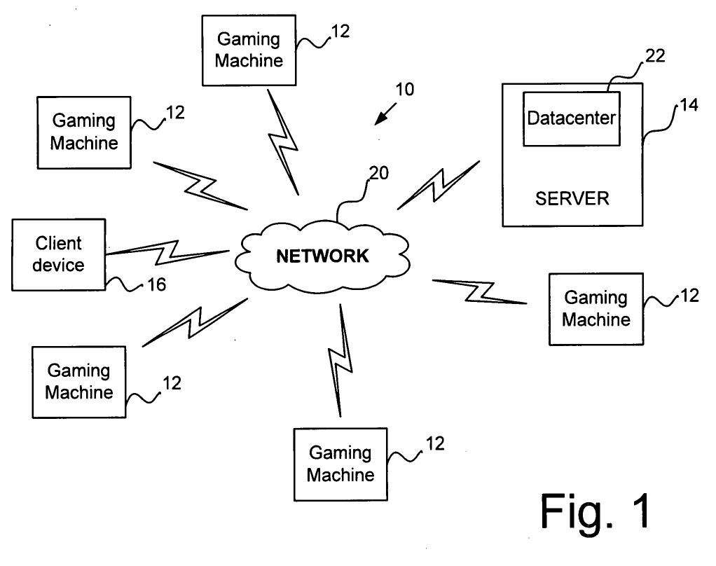

FIG. 1 illustrates an exemplary network 10 in which a system, devices and a method, consistent with the present invention, may be implemented. The network 10 may include multiple gaming machines 12 connected to a server 14 via a network 20. The network 20 of the present invention is the Internet and could be reached using a solid wired line, Wi-Fi, WiMAX or a combination thereof. Two gaming machines 12 and one server 14 have been illustrated connected to the network 20 for simplicity. In practice, there may be more or gaming machines 12 and servers 14 without departing from the scope of the present invention.

The gaming machines 12 may include devices, such as gaming consoles, slot machine and digital assistants, mobile phones, or the like, capable of connecting to the network 20 and adapted to carry on gaming thereon. The gaming machines 12 may transmit data over the network 20 or receive data from the network 20 via a wired, wireless, or optical connections.

The server 14 may include one or more types of computer system, such as a mainframe, minicomputer, or personal computer, capable of connecting to the network 20 and adapted to communicate with the gaming machines 12. The server 14 may transmit data over the network 20 or receive data from the network 20 via a wired, wireless, or optical connection.

In an implementation consistent with the present invention illustratively embodied herein, the server 14 includes a datacenter 22 connected to the gaming machines 12. The server 14 stores data information about the gaming machines 12 that can be accessible via client devices 16.

Exemplary Client Architecture

The following discussion provides a brief, general description of an exemplary computer apparatus in which at least some aspects of the present invention may be implemented. The present invention will be described in the general context of computer-executable instructions, such as program modules, being executed by a computerized device. However, other apparatuses may affect methods presented in embodiments of the present invention. Program modules may include routines, programs, objects, components, data structures, applets, WEB 2.0 type of evolved networked centered applications, etc. that perform a task(s) or implement particular abstract data types. Moreover, those skilled in the art will appreciate that at least some aspects of the present invention may be practiced with other configurations, including hand-held devices, multiprocessor system, microprocessor-based or programmable consumer electronics, network computers, minicomputers, set top boxes, mainframe computers, gaming console and the like. At least some aspects of the present invention are practiced in distributed computing environments where tasks are performed by remote processing devices linked through a communications network as exemplified in FIG. 1. In a distributed computing environment, program modules may be located in local and/or remote memory storage devices.

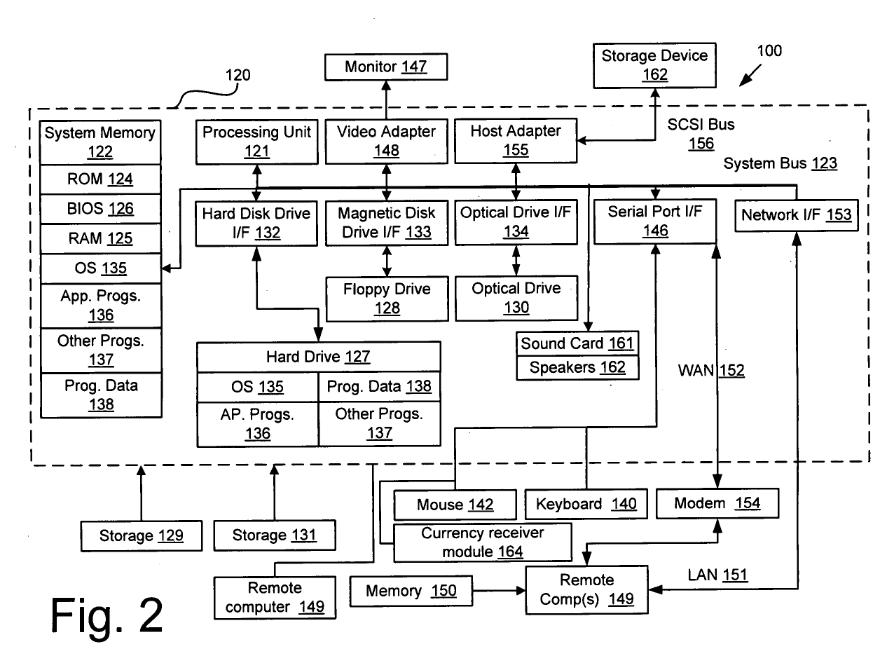

With reference to FIG. 2, an exemplary apparatus 100 for implementing at least some aspects of the present invention includes a general purpose-computing device in the form of a computer 120 or in the form of a gaming machine. The computer 120 may include a processing unit 121, a system memory 122, and a system bus 123 that couples various system components, including the system memory 122, to the processing unit 121. The system bus 123 may be any of several types of bus structures including a memory bus or memory controller, a peripheral bus, and a local bus using any of a variety of bus architectures. The system memory may include read only memory (ROM) 124 and/or random access memory (RAM) 125. A basic input/output system 126 (BIOS), containing basic routines that help to transfer data between elements within the computer 120, such as during start-up, may be stored in ROM 124. The computer 120 may also include a hard disk drive 127 for reading from and writing to a hard disk, (not shown), a magnetic disk drive 128 for reading from or writing to a (e.g., removable) magnetic disk 129, and an optical disk drive 130 for reading from or writing to a removable (magneto) optical disk 131 such as a compact disk or other (magneto) optical media. The hard disk drive 127, magnetic disk drive 128, and (magneto) optical disk drive 130 may be coupled with the system bus 123 by a hard disk drive interface 132, a magnetic disk drive interface 133, and a (magneto) optical drive interface 134, respectively. The drives and their associated storage media provide nonvolatile (or persistent) storage of machine-readable instructions, data structures, program modules and other data for the computer 120. Although the exemplary environment described herein employs a hard disk, a removable magnetic disk 129 and a removable optical disk 131, these skilled in the art will appreciate that other types of storage media, such as magnetic cassettes, flash memory cards, digital video disks, Bernoulli cartridges, random access memories (RAMs), read only memories (ROM), remote cloud storage and the like, may be used instead of, or in addition to, the storage devices introduced above.

A number of program modules may be stored on the hard disk 127, magnetic disk 129, (magneto) optical disk 131, ROM 124 or RAM 125, such as an operating system 135 (for example, Windows® NT.RTM. 4.0, sold by Microsoft® Corporation of Redmond, Wash.), one or more application programs 136, other program modules 137 (such as “Alice”, which is a research system developed by the User Interface Group at Carnegie Mellon University available at www.Alice.org, OpenGL from Silicon Graphics Inc. of Mountain View Calif., or Direct 3D from Microsoft Corp. of Bellevue Wash.), and/or program data 138 for example. Programs modules dedicated to gaming machines are considered within the scope of the present description.

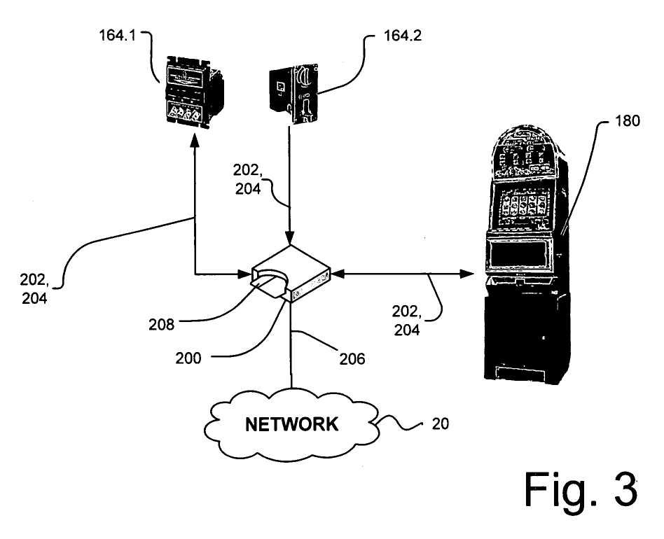

A user may enter commands and data into the computer 120 through input devices, such as a keyboard 140, a camera 141 and pointing device 142 for example. Other input devices (not shown) such as a microphone, joystick, game pad, satellite dish, scanner, a touch sensitive screen, accelerometers adapted to sense movements of the user or movements of a device, or the like may also be included. A currency receiver module 164 is also connected with the computer 120. The currency receiver module 164 is used when the computer 120 is embodied as a gaming machine. These and other input devices are often connected to the processing unit 180 and could either be a bills receiving module 164.1 or a coins receiving module 164.2 (illustrated on FIG. 3) through a serial port interface 146 coupled to the system bus. However, input devices may be connected by other interfaces, such as a parallel port, a game port, blue tooth connection or a universal serial bus (USB). For example, since the bandwidth of the camera 141 may be too great for the serial port, the video camera 141 may be coupled with the system bus 123 via a video capture card (not shown). The video monitor 147 or other type of display device may also be connected to the system bus 123 via an interface, such as a video adapter 148 for example. The video adapter 148 may include a graphics accelerator. One or more speaker 162 may be connected to the system bus 123 via a sound card 161 (e.g., a wave table synthesizer such as product number AWE64 Gold Card from Creative® Labs of Milpitas, Calif.). In addition to the monitor 147 and speaker(s) 162, the computer 120 may include other peripheral output devices (not shown), such as a printer, a hi-definition television and a scanner for example. As an alternative or an addition to the video monitor 147, a stereo video output device, such as a head mounted display or LCD shutter glasses for example, could be used.

Alternatively, vintage gaming machines could rely on older automated systems and be built with a primary controller providing the intelligence of the machine (e.g. to provide odds) and an input output controller adapted to communicate with exterior components. The present patent application if more directed to state of the art gaming or amusement machines but nonetheless encompasses vintage gaming machines architecture.

The computer 120 may operate in a networked environment that defines logical connections to one or more remote computers, such as a remote computer 149. The remote computer 149 may be another computer, a server, a router, a switch, a network PC, a peer device or other common network node, and may include many or all of the elements described above relative to the computer 120. The logical connections depicted in FIG. 2 include a local area network (LAN) 151 and a wide area network (WAN) 152, an intranet and the Internet.

When used in a LAN, the computer 120 may be connected to the LAN 151 through a network interface adapter (or “NIC”) 153. When used in a WAN, such as the Internet, the computer 120 may include a modem 154 or other means for establishing communications over the wide area network 152 (e.g. TCP/IP, Wi-Fi, WinMax, Ethernet, . . . ). The modem 154, which may be internal or external, may be connected to the system bus 123 via the serial port interface 146 or another type of port interface. In a networked environment, at least some of the program modules depicted relative to the computer 120 may be stored in the remote memory storage device. The network connections shown are exemplary and other means of establishing a communications link between the computers may be used.

Turning now to FIG. 3 illustrating a computerized gaming machine 180 to which is connected a currency media reader hub 200. The gaming machine 180 is embodied as a “slot machine”, an amusement machine or a gaming machine adapted to receive bills and coins respectively with a bills receiving module 164.1 and a coins receiving module 164.2. The receiving modules 164.1, 164.2 are generally physically installed on the gaming machine 180 to receive physical money from a player. The money put in the machine allows a player to use the gaming machine 180. The receiving modules 164.1, 164.2 are operatively connected with the gaming machine 180 using either a pulse string communication mode 202 or a serial port communication mode 204. A communication protocol is used to transmit signals from the receiving modules 164 to the gaming machine 180 in accordance with the amount of money received by the receiving modules 164. In contrast, TCP/IP communication 206 is used between the currency media reader hub 200 and the network 20 (e.g. generally Internet).

The currency media reader hub 200 is a physical apparatus generally adapted to be installed on existing gaming machines 180. The currency media reader hub 200 can be retrofitted on existing gaming machines 180. Existing gaming machines 180 are generally equipped with receiving modules 164.1, 164.2 to receive money from a player. The currency media reader hub 200 is then connected in series between the receiving modules 164.1, 164.2 and the electronic system of the gaming machine 180. Alternatively, new gaming machines 180 come with the currency media reader hub 200 already installed thereon.

Communication languages that are generally used by receiving modules 164.1, 164.2 to transfer data and instructions with the gaming machine 180 are used by the currency media reader hub 200 to transmit data between the receiving modules 164.1, 164.2 and the electronic system of the gaming machine 180. The currency media reader hub 200, can automatically select the proper communication language, normally a pulse string communication mode, a serial communication mode or a universal serial bus communication mode, once each module 164 and the gaming machine 180 is connected thereto. In other words, the currency media reader hub 200 emulates a receiving module 164 on one side and emulates a gaming machine 180 on the other side.

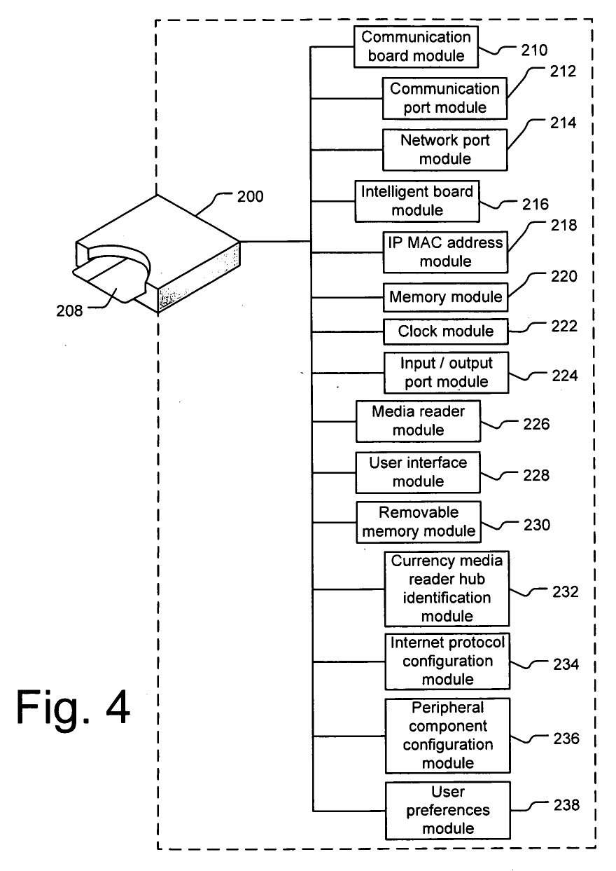

As appreciated in FIG. 4, the currency media reader hub 200 comprises a plurality of modules interacting together to provide the desired functions. The currency media reader hub 200 allows a player to prove that s/he is the holder or a determined amount of money that can be used in the gaming machine 180. The player's money can be virtually secured in a magnetic card, a chip-equipped card, a key, an RFID device or any other virtual currency holding media suitable to carry virtual money. In a preferred embodiment, virtual money is secured in an encrypted chip equipped card 208 carried by the player and inserted in the currency media reader hub 200 of gaming machines 180. The player can make use of the amount of virtual money stored on the card 208 when the key 208 is readable by the currency media reader hub 200. It has to be noted that the currency media reader hub 200 has both reading and writing capability and as such is adapted to modify the data, the amount of money or other information, stored on the card 208.

Still on FIG. 4, the currency media reader hub 200 of the present embodiment includes a communication board module 210 utilized to manage communication to/from the currency media reader hub 200. In this respect, the communication board module 210 further defines a communication port module 212 adapted to connect with peripheral components, like the receiving modules 164.1, 164.2, and a network port module 214 adapted to connect to the network 20. An intelligent board module 216 provides a series of other modules 218-224 adapted to manage the communication between the currency media reader hub 200 and a server 14. The intelligent board 216 includes an IP MAC address module 218 providing a unique address to the currency media reader hub 200 when connected to Internet, a memory module 220 adapted to store data therein, a clock module 222 to synchronize communications between the currency media reader hub 200 and other parties on the network 20 and with the receiving modules 164.1, 164.2 and an input/output port module 224 adapted to connect to other modules of the currency media reader hub 200. In an alternate embodiment the communication board 210 and the intelligent board 216 could be merged into a single boards without departing from the scope of the present invention. Should a single board be used, the communication board 210 and the intelligent board 216 would be found in portions of the single board and still be found thereon.

The currency media reader hub 200 is further equipped with a media reader module 226 adapted to read and write data on the card 208, a user interface module 228 comprising interacting interfaces that could include, but not limited to, push buttons and a screen to display dialogues for the player to interact with. A removable memory module 230 is connectable to the currency media reader hub 200 to carry and transmit information providing a unique identification to the currency media reader hub 200 and configuration data desirable to properly manage the currency media reader hub 200 and its communications with the network 20. For instance, the removable memory module 230, that is embodied herein as a SIM card, includes a currency media reader hub identification module 232 providing a unique ID to the currency media reader hub 200, an Internet protocol configuration module 234, a peripheral component configuration module 236 adapted to further adjust the communication with the receiving modules 164.1, 164.2 and a user preference module 238 adapted to properly dialog and interact with players primarily through the user interface module 226 discussed above.

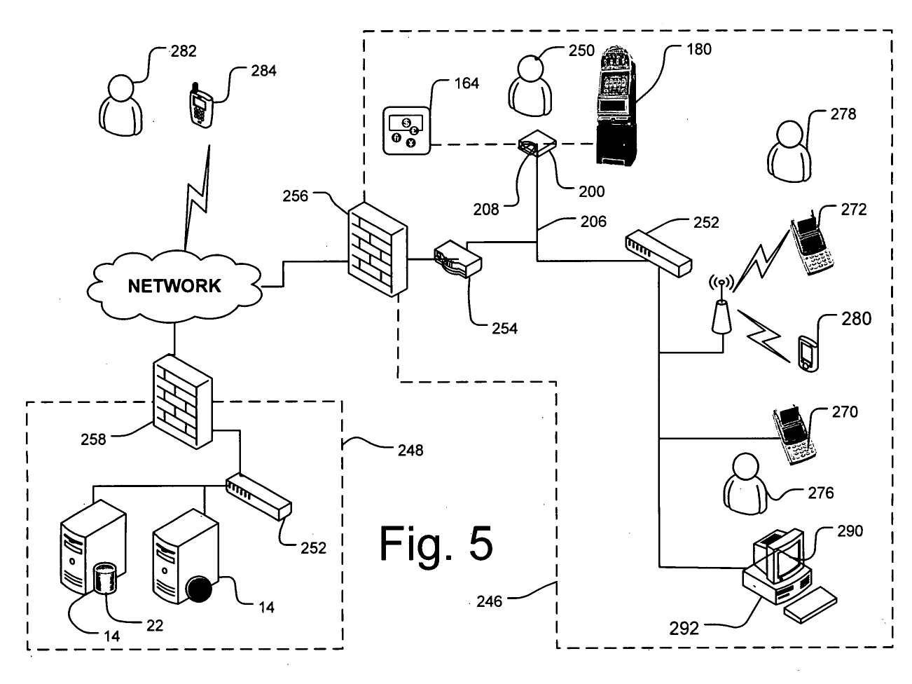

Referring now to FIG. 5 illustrating an exemplary layout of a typical casino 246 with its surrounding environment. The gaming machine 180, with corresponding receiving modules 164.1, 164.2 and currency media reader hub 200 installed thereto, is available for a player/card holder/user 250. The currency media reader hub 200 is connected to an Ethernet network switch 252 that is connected to an Ethernet router 254 and protected with a firewall 256 before connecting to the network 20. The currency media reader hub 200 is thus connected via TCP/IP through the network 20 and the firewall 258 of the database provider 248. The connection of the currency media reader hub 200 to the servers 14 and the database 22 of the database provider 248 is performed via another Ethernet network switch 252.

The whole communication layout is preferably encrypted and relays data in real time between the currency media reader hub 200 and the database provider 248. The database provider 248 identifies each currency media reader hub 200 with its unique associated currency media reader hub identification 232. The currency media reader hub 200 witnesses each credit/debit event occurring with the receiving modules 164 and relays the information to the database provider 248 via the network 20. The database 22 records each event of the receiving modules 164 for activity recordation and statistical purposes.

The gaming machine 180 is also connected to the of the currency media reader hub 200 that witnesses each money transaction (e.g. debit/credit) performed by the gaming machine 180 with the player and relays the information to the database provider 248 via the network 20. For example, a player (e.g. card holder) is given a card 208. This card can be an identification card or can be anonymous. The player may insert his card 208 in the currency media reader hub 200 and proceed to transfer currency to the gaming machine 180 through any of the payment receiving modules 164, or directly from the card 208 itself. He may also proceed to transfer currency from the gaming machine 180 back to the currency media reader hub 200. The currency media reader hub 200 will account for any currency transferred in or out of the gaming machine 180 and link it to the card 208 belonging to the player. This constitutes an exemplary payment transaction. The currency media reader hub 200 witnesses when the gaming machine 180 puts money on the player's card 208. The currency media reader hub 200 also witnesses money transfer between the player's card 208 and the gaming machine 180 when the player lose, accounts the remaining amount of money on the card 208 and sends the information to the database 22. Other forms of information storable on the card 208 may include card events (such as card insertions and removals from the currency media reader hub 200) and gaming machine's related events (such as restarts and errors). All transactions are sent to the database 22 for safekeeping and reporting.

If, for any reasons, the network 20 is down, all transactions between the card 208 and the gaming machine 180 are stored in the memory module 220 of the currency media reader hub 200. The database 22 is updated when the currency media reader hub 200 connects with the database 22. The gaming machine 180 is therefore operational and can be used by players when disconnected from its network 20.

Still in FIG. 5 one can appreciate a point of sale (POS) terminal 270 connected to the network 20 via TCP/IP. A point of sale terminal 270 is an apparatus allowing to connect with a card 208 without the currency media reader hub 200 and offers a series of functions. The point of sale terminal 270 is hard wired to the network 20 while the point of sale terminal 272 is wirelessly connected to the network 20 via a wireless router 274. The point of sale terminal 270 can illustratively be operated by a casino manager 276 who can add, or withdraw, money from any card 208. Other administrative functions are available through the point of sales terminal 270. For instance, a floor supervisor 278 of the casino 246 can remotely use the wireless point of sales terminal 270 reset a password of a card 208 forgotten by its player, set a maximum amount of money that could be held on a player's card 208 or get reports from a server 14.

Other devices such as a wireless personal digital assistant 280 (PDA) can alternatively perform operations performed by the point of sale terminal 270 that do not require communication with a card 208. Those functions are mainly auditing functions.

A web management interface 290 can be accessed from a web browser on a computer 292 to send query to the database 22. For instance, the query can inquire the use of a particular gaming machine 180 at a specific period of time. All money transactions between the player's card 208 and the gaming machine 180 can be retrieved or all transactions of a particular player can equally be retrieved just like many other statistics. System users may login to a web site (web interface) to view reports on transactions sent by the card readers in their location. These reports may include card 208 data, payment data, currency media reader hub 200 location information, cardholder information, and gaming machine 180 statistics. The web interface may be accessed using any web-enabled device such as a PC, PDA 280, or smart phone 284. The live data may include a location snapshot, card transactional history and cardholder statistics, as well as any data available from the database 22 via a web interface.

An external auditor 282 can connect the network-based system illustrated in FIG. 5 with a suitable communication tool. In the present example the external auditor 282 (who could be the owner of the casino 246 for instance) could monitor financial data of all the gaming machines 180 in real time with a smart phone 284.

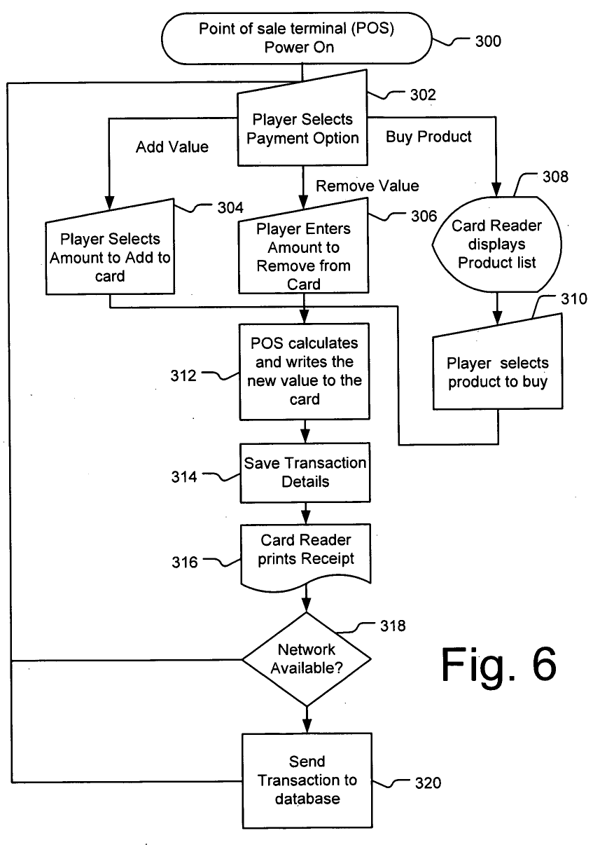

An exemplary flow chart of a typical transaction performed with a card 208 is illustrated in FIG. 6. The point of sale terminal 270 is powered 300 and the player selects a payment option 302. The player can add money 304 to the card 208, remove money 306 from the card 208 or buy a product 308 with the money stored on the card 208. A product is selected 310 if the player buys a product 308. The point of sale terminal 270 calculates and updates 312 the amount of money stored on the player's card 208. Transactions details are saved 314 in the point of sale terminal 270 memory module and a receipt is printed 316. The transaction data is sent to the database 22 if the network 20 is available 318. In contrast, if the network is not available, the point of sale terminal 270 keeps the data of the previous transaction in its memory module and is available to process another event.

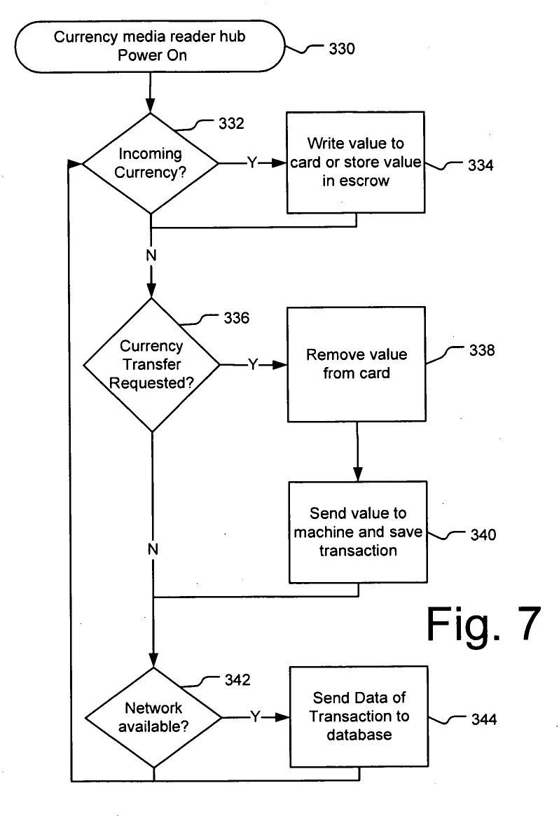

Another exemplary flow chart can be appreciated in FIG. 7. The currency media reader hub 200 is powered 330 and is ready to receive money 332 via receiving modules 164. The value of the amount of money stored on the card 208 is updated if money is added to the currency media reader hub 200. The updated value is stored in an escrow if no card 208 is inserted in the currency media reader hub 200 waiting to be put on a card 208. Currency transfer 336 might be requested and the card 208 is updated accordingly 338 while the transferred amount is sent to the currency media reader hub 200 for use with the gaming machine 180 associated therewith. The database 22 is updated if the network 22 is available 342 by sending transaction data to the database 22.

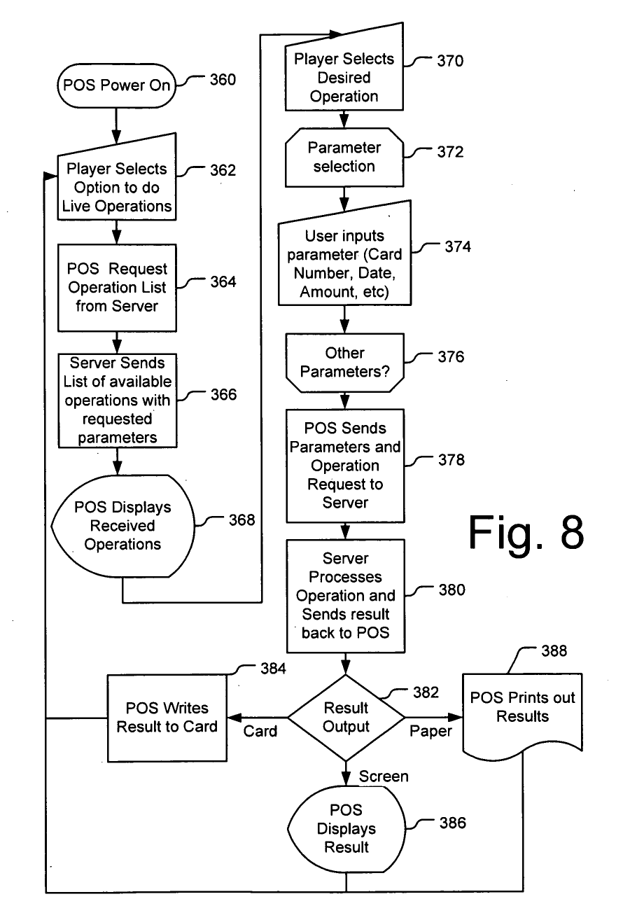

FIG. 8 illustrates exemplary steps of events performed via the user interface module of the point of sale terminal 270. The point of sale terminal 270 is powered 360 and offers a series of options 362 available to the player. The player selects operations that can be done when the point of sale terminal 270 is connected to the network 20 in the present example. The point of sale terminal 270 requests to the server 14 the list of operations available to the player 364. The server 14 responds by sending the list of operations accessible to the player (given the access rights given to the player) with associated parameters 366. The point of sale terminal 270 displays the list of available operations 368 and the player selects the desired operation 370 and selects the relevant parameter 372. The player inputs the requested parameters 374 and other needed parameters 376 with the user interface module 228 of the point of sale terminal 270. A corresponding request is sent to the server 378 that processes the desired operation and sends back results 380 to the point of sale terminal 270 via the network 20. The result of the operation 382 is acknowledged by updating 384 the card 208 accordingly, display the updated information 386 with the user interface module 228 or print same 388. The whole process can begin a new cycle by offering a player a series of options 362.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A currency media reader hub comprising:
a communication board module comprising
a communication port module adapted to connect the currency media reader hub with a peripheral component;
a network port module adapted to connect the currency media reader hub to a network;
a currency media reader module connected to the communication board module, the currency media reader module being adapted to communicate with a virtual currency holding media and transfer data between the communication board module and the virtual currency holding media;
a user interface module connected to the communication board and adapted to display a currency value stored on the virtual currency holding media; and
an intelligent board module connected to the communication board to provide communication capability with the network, the intelligent board module comprising
an IP MAC address module adapted to identify the currency media reader hub on the network;
a memory module for storing data;
a clock module; and
an input/output port module.

2. The currency media reader hub of claim 1, further comprising a removable memory module connected to the intelligent board.

3. The currency media reader hub of claim 2, wherein the removable memory module is adapted to include:
a currency media reader hub identification module;
an internet protocol configuration module;
a peripheral component configuration module; and
a user interface configuration module.

4. The currency media reader hub of claim 3, wherein the removable memory module is a SIM card.

5. The currency media reader hub of claim 1, wherein the communication port module is a TCP\IP port and the currency media reader hub is connectable therewith to a server.

6. The currency media reader hub of claim 1, wherein the communication port module is adapted to use one of a pulse string communication mode, a serial port communication mode and a universal serial bus communication mode with the peripheral component.

7. The currency media reader hub of claim 1, wherein the currency media reader hub is adapted to determine which communication mode is adapted to communicate with the peripheral component.

8. The currency media reader hub of claim 1, wherein the communication port module is a currency receiver module.

9. The currency media reader hub of claim 1, wherein the currency media reader hub is adapted to be connected to a gaming machine and to emulate a currency receiver module for the gaming machine.

10. The currency media reader hub of claim 1, wherein the currency media reader hub is adapted to be connected to a gaming machine and to emulate a gaming machine for a currency receiver module.

11. The currency media reader hub of claim 1, wherein the currency media reader hub is adapted to allow playing a game on a gaming machine when the currency media reader is online or offline with a server via the network.

12. The currency media reader hub of claim 1, wherein the currency media reader hub is adapted to communicate a point of sale terminal via the network.

13. The currency media reader hub of claim 1, wherein the currency media reader hub is adapted to be contacted with an Internet browser.

14. A method for connecting a currency media reader hub to a gaming machine, the method comprising:
disconnecting a currency receiver module from the gaming machine;
connecting the currency receiver module to the currency media reader hub; and
connecting the currency media reader hub to the gaming machine so that the currency receiver module and the gaming machine communicate therebetween.

15. The method for connecting a currency media hub to a gaming machine of claim 14, comprising connecting the currency media reader hub to Internet via TCP/IP.

16. The method for connecting a currency media hub to a gaming machine of claim 14, wherein the connection between the currency receiver module and the currency media reader hub uses one of a pulse string communication mode, a serial communication mode and a universal serial bus mode.

17. The method for connecting a currency media hub to a gaming machine of claim 14, wherein the connection between the gaming machine and the currency media reader hub uses one of a pulse string communication mode, a serial communication mode and a universal serial bus mode.

18. A computer readable media comprising computer executable instruction providing a method for connecting a currency media reader hub to a gaming machine, the method comprising selecting a communication mode suitable to communicate between the gaming machine and the currency media reader hub, the communication mode being selected from a pulse string communication mode, a serial communication mode and a universal serial bus mode.

19. The computer readable media of claim 18, wherein the method further comprises:
connecting a peripheral component module;
determining a type of peripheral component module connected to the currency media reader hub; and
selecting the communication mode adapted to establish communication between the peripheral component module and the currency media reader hub.
